(19) United States
(12) Patent Application Publication
(10) Pub. No.: US 2022/0289940 A1
(43) Pub. Date: Sep. 15, 2022

(54) THERMAL CONDUCTIVE FILLER AND PREPARATION METHOD THEREOF

(71) Applicant: EVONIK OPERATIONS GMBH, Essen (DE)

(72) Inventors: Shuangquan HU, Shanghai (CN); Yuan-Chang HUANG, Taipei City (TW)

(73) Assignee: EVONIK OPERATIONS GMBH, Essen (DE)

(21) Appl. No.: 17/636,886

(22) PCT Filed: Aug. 24, 2020
(86) PCT No.: PCT/CN2020/110739

§ 371 Date: Feb. 20, 2022

(30) Foreign Application Priority Data
Aug. 23, 2019 (CN) PCT/CN2019/102166

(51) Int. Cl. C08K 3/38; C08K 3/013; C08K 3/22; C08K 3/36

(52) U.S. Cl. CPC C08K 3/38; C08K 3/013; C08K 3/22; C08K 3/36; C08K 2003/385; C08K 2201/001; C08K 2201/005; C08K 2201/011; B82Y 30/00

(57) ABSTRACT

A method to prepare a thermal conductive filler, particularly a thermal conductive filler for preparation of a thermal conductive material with reduced viscosity, comprising the step of dry mixing a platelet boron nitride with a fumed silica or a fumed metal oxide with a primary particle size of 1-200 nm. A thermal conductive filler, a thermal conductive material and an electronic device are also provided.

### TECHNICAL FIELD

The invention relates to a dry mixing method to perform surface treatment of boron nitride powders.

### BACKGROUND ART

Heat management of electronic devices is very important as the microelectronic devices are becoming smaller and more powerful. Thermal conductive material comprising a resin material and an insulative thermal conductive filler is useful for such heat management. Typically, aluminum oxide, magnesium oxide, zinc oxide, aluminum nitride and boron nitride are used as thermally conductive fillers in thermal conductive materials.

Hexagonal boron nitride (hBN) is especially useful for its excellent heat transfer characteristics, physical-chemical stability and relatively low cost. It is very important to reach high loading of boron nitride to get high thermal conductivity. However, due to the platelet structure of hBN, it is easy for hexagonal boron nitride to increase the viscosity of the resin and this limits the loading of boron nitride including uniform dispersion of boron nitride in resin, and thus, the thermal conductivity of the thermal conductive material.

To reduce the viscosity of thermal conductive material with hBN as thermal conductive filler, it is necessary to treat hBN. hBN treatment in prior art is based on complex surface treatment, including high temperature calcination, chemical reaction or forming spherical boron nitride particles which are larger in particle size.

As an example of a wet process treatment, US20070054122A1 discloses that colloidal silica with particle size ranging from 10 to 100 nm was used in coating of boron nitride in water system to increase the number of reactive groups, followed by calcination under 200-1100° C.

The disadvantages with the colloidal silica are that in the wet process there is a potential risk of sedimentation, and additional steps of drying and calcination are required.

WO2010141432A1 discloses surface treatment of BN particle. The surface treatment typically involves contacting the untreated BN particles with a precursor compound of the coating material to form a BN intermediate filler, and thermally or chemically treating the BN intermediate filler to form the coated BN filler comprising the coating material disposed on a surface thereof. The thermal treatment can be performed at a temperature of 500 to 1500° C. for e.g., about 4 to about 18 hours.

U.S. Pat. No. 7,445,797B2 discloses a boron nitride composition having its surface treated with a coating layer comprising a zirconate coupling agent. The boron nitride was chemically modified by the zirconate coupling agent.

Considering the documents of prior art, there is a need to provide an alternative simple method to treat platelet boron nitride.

### SUMMARY OF THE INVENTION

The inventors surprisingly found a simple method to substantially reduce the viscosity of a thermal conductive material with a platelet boron nitride. The invention uses a dry mixing method to treat platelet boron nitride surface with fumed silica or fumed metal oxides. With this method, it is possible to reduce the viscosity of a thermal conductive material with boron nitride, thus boron nitride can be conveniently and uniformly dispersed in the thermal conductive material and the loading of boron nitride in the thermal conductive material can be increased. Also, as it should be, such surface treatment to boron nitride does not substantially affect the thermal conductivity of the thermal conductive material with the boron nitride, and the thermal conductive material with the surface treated boron nitride has good thermal conductivity, i.e., the thermal conductivity of the thermal conductive material with such surface treated boron nitride is comparable to the thermal conductivity of the thermal conductive material with the same amount of untreated boron nitride.

Based on the prior art, it could be expected that if a fumed silica or a fumed metal oxide were dryly mixed with a platelet boron nitride, it would be hard to disperse the fumed silica or the fumed metal oxide on the surface of the platelet boron nitride. Furthermore, it could be expected that addition of the fumed silica or the fumed metal oxide would increase the viscosity of a thermal conductive material with the dryly mixed platelet boron nitride and the fumed silica or the fumed metal oxide as a filler. However, the inventors surprisingly found that the viscosity of a thermal conductive material comprising a filler with platelet boron nitride can be decreased significantly when the platelet boron nitride is properly surface treated with a fumed silica or a fumed metal oxide by means of dry mixing.

Without wishing to be bound by any theory, it is believed that the fumed silica or the fumed metal oxide particles are physically fixed and/or distributed on the surface of the platelet boron nitride powder by the mixing, although there is no chemical reaction between the fumed silica or the fumed metal oxide particles and the platelet boron nitride powder. The silanol groups or the hydroxyl groups of the fumed silica or the fumed metal oxide particles, respectively, present on the surface of the platelet boron nitride powder, may further be reacted with some organic groups of the other materials such as silanes, to bring about a surface modification of such silica or metal oxide particles.

The invention provides a method to prepare a thermal conductive filler, particularly a thermal conductive filler for preparation of a thermal conductive material with reduced viscosity, comprising the step of,
(i) dry mixing a platelet boron nitride with a fumed silica or a fumed metal oxide with a primary particle size of about 1-200 nm, preferably about 5-100 nm; and optionally the steps:
(ii) mixing a silane into the mixture obtained in step (i); and (iii) heating the mixture obtained in step (ii).

The thermal conductive filler prepared according to the method of the invention may be used to prepare a thermal conductive material with reduced viscosity. Thus, the invention provides a surface treatment method to a platelet boron nitride to prepare a thermal conductive filler which reduces the viscosity of a thermal conductive material. In other words, the method of the invention prepares a thermal conductive filler which reduces the viscosity of a thermal conductive material when the thermal conductive material comprises the thermal conductive filler prepared according to the method of the invention, compared with a thermal conductive material that does not comprise the thermal conductive filler, for example a thermal conductive filler with untreated platelet boron nitride. At the same time, the surface treatment to the platelet boron nitride according to the invention will not substantially impair the thermal conductivity of platelet boron nitride. Therefore, the thermal conductive material prepared based on the thermal conductive filler of the invention has both reduced viscosity and good thermal conductivity.

Therefore, the invention provides a surface treatment method to prepare a thermal conductive filler capable of reducing the viscosity of a thermal conductive material comprising the thermal conductive filler.

In some embodiments, in step (i), the platelet boron nitride and a fumed silica or a fumed metal oxide are mixed to obtain a homogeneous mixture. Particularly, fumed silica or fumed metal oxide particles are evenly distributed on the surface of the platelet boron nitride.

In some embodiments, the mixing in step (i) is done at a speed of above 100 rpm, preferably above 1000 rpm, for example 1100 rpm, 1200 rpm, 1300 rpm, 1400 rpm, more preferably above 1500 rpm, for example 2000 rpm, even more preferably above 2500 rpm. The mixing time may be for example, 5 seconds, preferably 20 or 30 seconds.

Step (ii) and step (iii) are optional. If no silane is used, these two steps are not included in the method. If a silane is used, these two steps are included in the method.

Thus, the invention provides a simple method to treat or modify surfaces of platelet boron nitride particles with fumed silica or fumed metal oxide to prepare a thermal conductive filler. Such thermal conductive filler can decrease the viscosity of a thermal conductive material comprising platelet boron nitride fillers.

In contrary to the wet process in prior art which involves drying a liquid component, the method to prepare a thermal conductive filler of the present invention is a dry mixing method. The term “dry mixing” in the invention means that no liquid component is needed to be dried out in the method. It is a convenient way to make a powder product from powder material sources. The surface treatment method of the invention does not involve any aqueous or liquid components such as aqueous silica or metal oxide, e.g. colloidal silica or water. The surface treatment method of the invention does not comprise a wet-blending or wet-mixing step, for example that is used in prior art documents.

The surface treatment method of the invention may be done without a calcination (or thermal treatment) (e.g. 500 to 1500° C., for about 4 to about 18 hours) step.

Step (i), or preferably the whole method consists of a dry mixing step. Thus, step (i), or preferably the whole method does not involve a liquid component that need to be dried out. The step (i) or preferably the whole method does not comprise any one of the following: calcination, any aqueous or liquid components such as aqueous silica or metal oxide, or water, e.g. for surface modification of boron nitride. The step (i) is a physical treatment step which does not comprise any chemical treatment (i.e., chemical reaction) of boron nitride.

The invention further provides a thermal conductive filler prepared according to the method of the present invention.

The invention further provides a thermal conductive filler comprising a platelet boron nitride powder, wherein fumed silica or fumed metal oxide particles are physically fixed on the surface of the platelet boron nitride powder, for example by mixing, optionally followed by mixing with a silane and heating; wherein the average particle size of the platelet boron nitride is 1-50 μm, preferably 2-20 μm; the fumed silica or the fumed metal oxide has a primary particle size of 1-200 nm, preferably 5-100 nm; and the amount of the fumed silica or the fumed metal oxide is 0.1-10 wt. %, preferably 2-5 wt. %, for example 2-4 wt. % based on the weight of boron nitride.

The structure of the thermal conductive filler determined e.g. by scanning electron microscope (SEM), shows that the fumed silica or the fumed metal oxide attach to the surface of platelet boron nitride homogeneously (see FIG. 1). The fumed silica or the fumed metal oxide particles are fixed physically and not chemically to the surface of the platelet boron nitride powder. This is very different from the boron nitride reported in the prior art that shows silica or metal oxide particles chemically bonded to the surface of the boron nitride.

The invention further provides a thermal conductive material, comprising:
A) a resin material;
B) a thermal conductive filler of the present invention dispersed in the resin material;
C) a solvent; and
D) a cross-linker; and optionally
E) a catalyst.

The thermal conductive material of the invention may contain 5-95 wt. %, preferably 30-95 wt. %, including 40-95 wt. %, 40-90 wt. %, 40-85 wt. %, 40-80 wt. %, 40-75 wt. %, 45-75 wt. %, 50-75 wt. %, 50-70 wt. %, 50-65 wt. %, 50-60 wt. %, of the platelet boron nitride (before surface treatment) based on the total weight of the thermal conductive material.

The invention further provides a method to prepare a thermal conductive material with reduced viscosity, comprising the step of adding the thermal conductive filler according to the present invention.

The invention further provides the use of fumed silica or fumed metal oxide and optionally a silane for preparation of a thermal conductive filler according to the present invention to reduce the viscosity of a thermal conductive material. The viscosity of the thermal conductive material can be substantially reduced when using a thermal conductive filler prepared by the method of the invention.

The invention further provides use of the thermal conductive filler of the present invention for preparation of a thermal conductive material. The thermal conductive material comprises the thermal conductive filler prepared according to the method of the invention.

The invention further provides a circuit sub-assembly, comprising a dielectric layer formed from the thermal conductive material of the invention. The thermal conductive material has a reduced viscosity.

In one embodiment, the dielectric layer is disposed on a conductive layer. The conductive layer can be patterned to form a circuit.

The invention further provides a circuit comprising the circuit sub-assembly of the invention.

The invention further provides an electronic device which comprises a dielectric layer formed from the thermal conductive material of the invention, or the circuit subassembly, or the circuit of the invention.

### Platelet Boron Nitride

The term “platelet boron nitride” in the invention refers to boron nitride in the form of platelets, which in particular includes hexagonal boron nitride in a platelet shape. Therefore, granulated hBN with a spherical shape is not included in the platelet boron nitride of the invention.

The average particle size of the platelet boron nitride may be 1-50 μm, preferably 2-20 μm.

### Fumed Silica or Fumed Metal Oxide

The fumed silica or the fumed metal oxide may be hydrophilic or hydrophobic (i.e. hydrophobically treated). Aqueous silicas or metal oxides, such as colloidal silicas are not included in the scope of the fumed silica or the fumed metal oxide of the invention. The inventors surprisingly found that hydrophobic silicas or metal oxides have better viscosity reduction performance than hydrophilic silicas or metal oxides. Therefore, hydrophobic silicas or metal oxides are preferred. The metal oxide preferably includes zirconium oxide, titanium oxide, zinc oxide, tin oxide, iron oxide, tungsten oxide, nickel oxide, copper oxide, magnesium oxide, manganese oxide, cerium oxide, aluminum oxide and any mixture thereof.

Examples of the fumed silica or the fumed metal oxide may be selected from the group consisting of AEROSIL® 200, AEROSIL® R 972, AEROSIL® R 711, AEROXIDE® Alu C and AEROXIDE® Alu C 805 from Evonik Industries AG, especially AEROXIDE® Alu C 805.

The fumed silica or the fumed metal oxide may have a primary particle size of 1-200 nm, for example 1-150 nm, preferably 5-100 nm.

The amount of the fumed silica or the fumed metal oxide relative to the amount of the boron nitride is important. Preferably the amount of the fumed silica or the fumed metal oxides is above 0.1 wt. %, for example above 0.2 wt. %, 0.3 wt. %, 0.4 wt. %, 0.5 wt. %, 0.6 wt. %, 0.7 wt. %, 0.8 wt. %, 0.9 wt. %, 1 wt. %, or above 1.5 wt. %, or above 2 wt. %, or above 2.5 wt. %, such as 0.1-10 wt. %, 0.2-10 wt. %, 0.3-10 wt. %, 0.4-10 wt. % 0.5-10 wt. %, 0.6-10 wt. %, 0.7-10 wt. % 0.8-10 wt. %, 0.9-10 wt. %, 1-10 wt. %, 1.5-10 wt. %, or 2-10 wt. %, 0.1-5 wt. %, 0.2-5 wt. %, 0.3-5 wt. %, 0.4-5 wt. % 0.5-5 wt. %, 0.6-5 wt. %, 0.7-5 wt. % 0.8-5 wt. %, 0.9-5 wt. %, 1-5 wt. %, 1.5-5 wt. %, or 2-5 wt. %, more preferably around 2-8 wt. %, for example around 2-6 wt. % or 2-5 wt. % or 2-4 wt. % based on the weight of boron nitride (before surface treatment).

### Silane Coupling Agent

The silane coupling agent in the present invention is conventional in the art. The silane may be selected from functional silanes, for example, vinyl silane oligomer or [3-(2,3-epoxypropoxy)propyl]trimethoxysilane.

In some examples, the amount of the silane may be from 0.5-10 wt. % based on the weight of boron nitride (before surface treatment).

In some examples, the silane is Dynasylan® Glymo or Dynasylan® 6498 or Dynasylan® MEMO or Dynasylan® 6598 from Evonik Industries AG, and the amount is 2 wt. % based on the amount of the boron nitride (before surface treatment).

### Resin Material

The resin materials in the invention are conventional in the art, including the resin materials used for plastic packaging of microelectronic devices. The resin materials may be selected from epoxy resins, polyimide resins, polypropylene resins, polyethylene resins, polystyrene resins, polyphenylene ether resins, polytetrafluoroethylene resins, polymethylpentene resins, polyphenylene sulfide resins, polybutadiene resins and silicone resins, preferably epoxy resins, for example D.E.R.™ 331 Liquid Epoxy Resin from Dow Chemical, which is a liquid reaction product of epichlorohydrin and bisphenol A, or polyphenylene ether (PPE) resins, for example NORYL™ SA9000 from SABIC, or hydroxyl-terminated liquid polybutadiene resins, for example POLYVEST® HT from Evonik Industries AG, which is a stereospecific, low viscous and hydroxyl-terminated liquid polybutadiene with a high content of double bonds having the following composition:

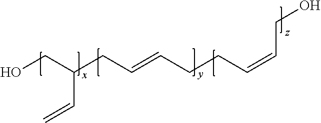

1,2-vinyl (x) approx. 22%,
1,4-trans (y) approx. 58%, and
1,4-cis (z) approx. 20%.

The amount of the resin material is conventional in the art. In some examples, the amount of the resin material is from 20-99 wt. %, preferably 30-70 wt. %, based on total weight of thermal conductive material.

### Solvent

The solvent is used to dilute the composition of the thermally conductive material. The solvent in the invention may be those conventional in the art, including dimethylformamide (DMF), N-methyl-2pyrrolidone (NMP), dimethylacetamide (DMAc), ethyl acetate (EAc), toluene, xylene, methyl isobutyl ketone (MIBK), preferably methyl ethyl ketone (MEK).

The amount of the solvent may vary. In some examples, the amount of solvent is from 0.1-50 wt. % based on the total weight of the thermal conductive material.

### Cross-Linker

The cross-linker is conventional in the art. It is used to solidify the resin and can be selected from common cross-linkers used in polymers. In some examples, 2-cyanoguanidine is preferred for epoxy resins.

Cross-linkers can be added to increase the cross-linking density of polymer(s). Examples of cross-linkers include, without limitation, triallylisocyanurate, triallylcyanurate, diallyl phthalate, divinyl benzene, and multifunctional acrylate monomers, and combinations thereof, all of which are commercially available, with triallylisocyanurate being particularly preferable. The cross-linking agent content of the polymer composition can be readily determined by the one of ordinary skill in the art, depending upon the desired flame retardancy of the composition, the amount of the other constituent components, and the other properties desired in the final product.

### Catalyst

The catalyst is conventional in the art. It is used to improve the solidification of the resin, and it could be common catalyst used in polymers. In some examples, 2-methylimidazole is preferred for epoxy resins.

The mixing speed in step (i) may be above 100 rpm, for example, above 200 rpm, 500 rpm, especially above 1000 rpm, 1100 rpm, 1200 rpm, 1300 rpm, 1400 rpm, or 1500 rpm, preferably above 1500 rpm, for example, above 2000 rpm, 2100 rpm, 2200 rpm, 2300 rpm, 2400 rpm, more preferably above 2500 rpm. There is no particular requirement to the upper limit of the mixing speed. In practice, for the sake of economic consideration, the mixing speed is typically below 100,000 rpm, 50,000 rpm, 20,000 rpm, 10,000 rpm, 5,000 rpm, 4,000 rpm, or even 3,000 rpm.

The mixing time of step (i) may be seconds, for example seconds, preferably ≥20 seconds or ≥30 seconds. There is no particular requirement to the upper limit of the mixing speed. In practice, for the sake of economic consideration, the mixing time is typically below 10 minutes, 5 minutes, 4 minutes, 3 minutes, 2 minutes, 1 minutes, 50 seconds, or even 40 seconds.

The mixing condition of step (ii) is conventional in the art, for example using dual asymmetric centrifugal mixing to mix silane with the mixture obtained in step (i).

In some embodiments, the mixing in step (ii) is performed at above 1000 rpm, preferably above 1500 rpm, more preferably above 2500 rpm for ≥10 seconds, preferably ≥20 or 30 seconds.

In some embodiments, the mixing in step (i) and/or (ii) is done by dual asymmetric centrifugal mixing at ≥2500 rpm for ≥30 seconds. The mixer maybe the speed mixer from Flack Fek., Inc.

The heating condition of step (iii) may be under 80-150° C. for 0.5 to 12 hours, for example under 105° C. for 1 hour.

In some examples, the fumed silica or the fumed metal oxides and the platelet boron nitride are physically mixed by tumbling. Then the silane is added into the mixture with tumbling, followed by heating.

This invention therefore provides an easy method to treat the boron nitride and substantially decrease the viscosity of a thermal conductive material comprising a resin material and the treated boron nitride, which makes high loading of boron nitride in the thermal conductive material with uniform dispersion possible and thus improves the thermal conductivity of the thermal conductive materials. This can successfully solve the technical problem of mixing boron nitride into a resin material uniformly. Uniform dispersion/distribution of boron nitride in thermal conductive material is very important to ensure an isotropic thermal conductivity of the thermal conductive material. Compared with prior art, the invention uses a dry mixing method and does not need high temperature (>800° C.) calcination. Furthermore, the dry mixing method makes the process quite easy and economically advantageous.

Other advantages of the present invention would be apparent for a person skilled in the art upon reading the specification.

### BRIEF DESCRIPTION OF DRAWINGS

FIG. 1 shows SEM photos of the thermal conductive filler prepared in Sample E of Example 1. FIG. 1A shows a low magnification (50000×) SEM photo, FIG. 1B shows a high magnification (200000×) SEM photo.

FIG. 2 shows the viscosity of the epoxy thermal conductive materials with different surface treated hBN PCTP 12 prepared in Example 1.

FIG. 3 shows the viscosity of the epoxy thermal conductive materials with different surface treated hBN PCTP 12 with or without silane treatment, prepared in Example 2.

FIG. 4 shows the viscosity of the epoxy thermal conductive materials with different surface treated hBN PCTP 8 prepared in Example 3.

FIG. 5 shows the viscosity of the epoxy thermal conductive materials with different mixing speed for Sample D prepared in Example 4.

FIG. 6 shows the viscosity of the epoxy thermal conductive materials with different amount of AEROSIL® R 711 in boron nitride, prepared in Example 5.

FIG. 7 shows the viscosity of the PPE thermal conductive materials with different surface treated hBN prepared in Example 6.

FIG. 8 shows the viscosity of the polybutadiene thermal conductive materials with different surface treated hBN prepared in Example 7.

FIG. 9 shows the viscosity of the epoxy thermal conductive materials with different surface treated hBN PCTP 12 prepared in Comparative Example 6.

### DETAILED DESCRIPTION OF THE INVENTION

To describe the content and effects of the present invention in detail, the present invention will be further described below in combination with the examples and comparative examples and with the related drawings.

### Equipment

The SEM photos were taken by Sirion 200 SEM from ThermoFisher Scientific (Oregon, USA).

Before SEM test, the thermal conductive filler sample was coated with gold by an ion sputter coater (Model ETD-2000C from Beijing Elaborate Technology Development Co., Ltd., Beijing, China) for 30 s.

The mixing was performed by dual asymmetric centrifugal mixing which was carried out with a SpeedMixer from FlackTek, Inc. (South Carolina, USA). The Turbula® T2F mixer from WAB Machaniery (Shenzhen) Co., Ltd. (Guangdong, China) was used in Example 4.

The viscosity was determined by a Brookfield DV-II+Pro Viscometer (Brookfield Co., Middleboro, Mass., USA). The measurements were tested under speeds of 6 rpm and 60 rpm.

The thermal conductivity was tested by laser flash method with a LFA 467 HyperFlash light flash apparatus from Netzsch-Geratebau GmbH, Germany.

### Materials

The hBN used in the examples were PCTP 8 and PCTP 12 from Saint-Gobain. Table 1 listed the parameters of these two hBN samples. The AEROSIL® silicas, SIPERNAT® silicas and AEROXIDE® aluminum oxides from Evonik Industries AG were employed in examples or comparative examples. The ADMAFINE® silicas are from Admatechs Company Limited. The parameters of these silica or metal oxides are listed in Table 2.

TABLE 1
parameters of different boron nitride samples

| | Average particle | Tamped | BET specific |
|---|---|---|---|
| Sample | size, μm | density, g/cm3 | surface area, m2/g |
| PCTP 8 | 8 | 0.5 | 3 |
| PCTP 12 | 12 | 0.5 | 4 |

TABLE 2
parameters of different silicas and metal oxides

| | Primary/ | | Tamped | BET |
|---|---|---|---|---|
| Silica or | median | | density, | surface area, |
| metal oxide | particle size | | g/L | m2/g |
| AEROSIL ® 200 | 12 | nm | 50 | 200 |
| AEROSIL ® R 974 | 12 | nm | 50 | 200 |
| AEROSIL ® R 711 | 12 | nm | 60 | 200 |
| AEROXIDE ® Alu C | 13 | nm | 50 | 100 |
| AEROXIDE ® Alu C | 13 | nm | 50 | 100 |
| 805 | | | | |
| SIPERNAT ® 622 | 4.5 | μm | 70 | 180 |

| | | | |
|---|---|---|---|
| LS | | | |
| ADMAFINE ® | 0.2~0.3 μm | — | 13~18 |
| SO-C1 | | | |
| ADMAFINE ® | 0.7~1.3 μm | — | 3~5.5 |
| SO-C4 | | | |
| ADMAFINE ® | 1.8~2.3 μm | — | 1.3~2.5 |
| SO-C6 | | | |

* Primary particle size for AEROSIL ® fumed silicas and AEROXIDE ® fumed aluminas, and median particle size for SIPERNAT ® precipitated silicas and ADMAFINE ® silicas. AEROSIL ® R 974 and AEROSIL ® R 711 are hydrophobic fumed silicas. AEROSIL® 200 is a hydrophilic fumed silica. AEROXIDE ® Alu C 805 is a hydrophobic fumed aluminum oxide. AEROXIDE ® Alu C is a hydrophilic fumed aluminum oxide. SIPERNAT ® 622 LS is a hydrophilic precipitated silica. ADMAFINE ® SO-C1, ADMAFINE ® SO-C4, ADMAFINE ® SO-C6 are hydrophilic silicas made by vaporized metal combustion method, and such silicas are not within the scope of the fumed silica of the invention.

The silanes used in the examples were Dynasylan® Glymo (3-glycidyloxypropyltrimethoxysilane), Dynasylan® 6498, which is a vinyl silane concentrate (oligomeric siloxane) containing vinyl and ethoxy groups, Dynasylan® MEMO which is a methacrylfunctional silane, and Dynasylan® 6598 which is an oligomeric siloxane containing vinyl, propyl and ethoxy groups. All these silanes are commercially available from Evonik Industries AG.

The resins used in the examples were D.E.R.™ 331 Liquid Epoxy Resin (from Dow Chemical), which is a liquid reaction product of epichlorohydrin and bisphenol A, NORYL™ SA9000, a polyphenylene ether (PPE) resin from SABIC, and POLYVEST® HT, a hydroxyl-terminated liquid polybutadiene resin from Evonik Industries AG.

In the examples, the cross-linker used was commercial 2-cyanoguanidine and the catalyst was commercial 2-methylimidazole to solidify the epoxy resin.

### Comparative Examples 1 and 2

Thermal conductive material Sample A without silica/metal oxide nor silane treatment was prepared as Comparative Example 1 as follows:

28 g D.E.R.™ 331 epoxy resin, 24 g methyl ethyl ketone (MEK) as a solvent and 28 g of a boron nitride PCTP 12 were mixed together with the dual asymmetric centrifugal mixing at 2500 rpm for 30 s.

Thermal conductive material Sample B with silane but without any oxide treatment was prepared as Comparative Example 2 as follows:

50 g of boron nitride PCTP 12 was placed in a 50 mL plastic vessel. Then 1 g Dynasylan® Glymo was added into the vessel, followed by tumbling with dual asymmetric centrifugal mixing at 2500 rpm for 30 s, then the mixture was heated in an oven at 105° C. for 1 hour to obtain a thermal conductive filler. After the thermal conductive filler was prepared, 28 g D.E.R.™ 331 epoxy resin, 24 g methyl ethyl ketone (MEK) as a solvent and 28 g treated boron nitride were mixed together with the dual asymmetric centrifugal mixing at 2500 rpm for 30 s.

The final thermal conductive materials were tested for viscosity under the rotor speed of 6 rpm and 60 rpm with a Brookfield DV-II+Pro Viscometer.

### Example 1

Thermal conductive material Samples C-G were prepared as follows,
a) preparation of thermal conductive fillers:
1) 47.5 g of boron nitride PCTP 12 was placed in a 50 mL plastic vessel.
2) Next, 2.5 g of AEROSIL® 200 or AEROSIL® R 974 or AEROSIL® R 711 or AEROXIDE® Alu C or AEROXIDE® Alu C 805 was put into the vessel.
3) The mixture in the vessel was tumbled with a dual asymmetric centrifugal mixer at 2500 rpm for 30 s.
4) Then 1 g Dynasylan® Glymo was added into the vessel, followed by tumbling with dual asymmetric centrifugal mixing at 2500 rpm for 30 s, then the mixture was heated in an oven at 105° C. for 1 hour.

In the prepared thermal conductive filler, the loading of fumed silica or fumed metal oxide was 5 wt. % and loading of silane was 2 wt. % based on the weight of untreated boron nitride.
b) preparation of thermal conductive materials:

After the thermal conductive filler was prepared, 28 g D.E.R.™ 331 epoxy resin, 24 g methyl ethyl ketone (MEK) as solvent and 28 g thermal conductive filler (treated boron nitride) were mixed together with the dual asymmetric centrifugal mixing at 2500 rpm for 30 s. The content of thermal conductive filler in the thermal conductive material was 50% after the solvent MEK was evaporated.

The final thermal conductive materials were tested for viscosity under the rotor speed of 6 rpm and 60 rpm with a Brookfield DV-II+Pro Viscometer.

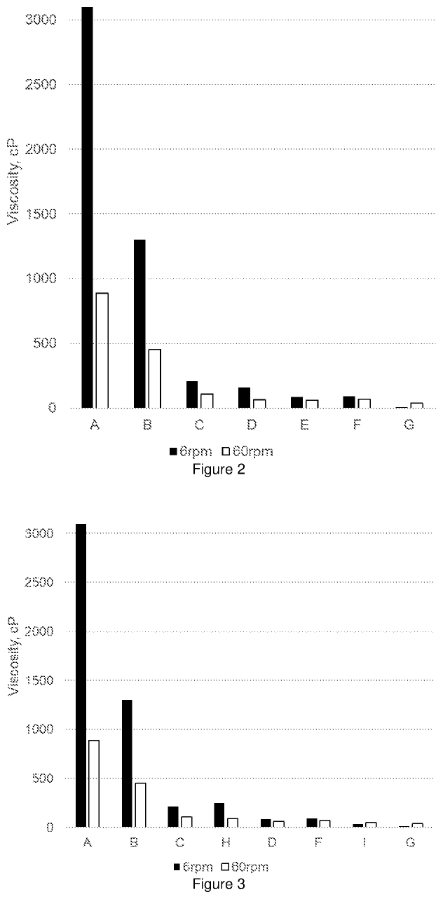

The viscosity results are summarized in Table 3. The comparison graphs are shown in FIG. 2.

TABLE 3
Effect of different fumed silica or fumed metal oxide in thermal conductive
materials with PCTP 12 hBN on viscosity at 6 rpm and 60 rpm

| | | wt. % Fumed | | Viscosity | Viscosity |
|---|---|---|---|---|---|
| | | silica or fumed | wt. % | at 6 rpm, | at 60 rpm, |
| Samples | Description | metal oxide | Silane | cP | cP |
| A | PCTP 12 | 0 | 0 | 3099 | 886 |
| B | PCTP 12/Dynasylan ® | 0 | 2% | 1300 | 450 |
| | Glymo | | | | |
| C | PCTP 12/AEROSIL ® | 5% AEROSIL ® | 2% | 210 | 107 |
| | 200/Dynasylan® Glymo | 200 | | | |
| D | PCTP 12/AEROSIL ® | 5% AEROSIL ® | 2% | 85 | 61 |
| | R 711/Dynasylan® Glymo | R 711 | | | |
| E | PCTP 12/AEROSIL ® | 5% AEROSIL ® | 2% | 160 | 66 |
| | R974/Dynasylan ® Glymo | R974 | | | |
| F | PCTP 12/AEROXIDE ® | 5% | 2% | 90 | 69 |
| | Alu C/Dynasylan ® Glymo | AEROXIDE ® | | | |
| | | Alu C | | | |
| G | PCTP 12/AEROXIDE ® | 5% | 2% | 10 | 38 |
| | Alu C 805/Dynasylan® | AEROXIDE ® | | | |
| | Glymo | Alu C 805 | | | |

As shown in Table 3 and FIG. 2, compared with Comparative Examples 1 and 2 (Samples A and B), all the fumed oxides tried in Samples C-G of Example 1 could greatly decrease the viscosity. Notably, thermal conductive materials with AEROSIL® R 974 and AEROSIL® R 711 treated hBN showed lower viscosity than the one with AEROSIL® 200, and similarly, thermal conductive material with AEROXIDE® Alu C 805 showed lower viscosity than the one with AEROXIDE® Alu C. This indicated that hydrophobic fumed silica or fumed metal oxides performed better in viscosity decrease than hydrophilic fumed silica or fumed metal oxides.

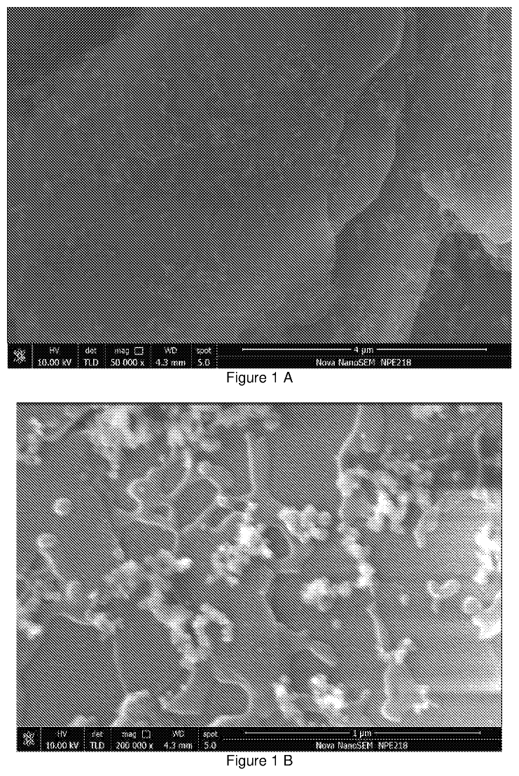

FIG. 1 shows SEM photos of the thermal conductive filler prepared in Sample E of Example 1. FIG. 1A shows that fumed silica AEROSIL® R 974 particles are homogeneously distributed on the surface of hBN. FIG. 1B shows that fumed silica AEROSIL® R 974 particles are attached to the surface of hBN. The photos indicate that fumed silica or fumed metal oxides could be attached on the surface of hBN with good dispersibility.

### Example 2

### hBN without Silane Treatment

The viscosity reduction performance of thermal conductive fillers without silane treatment were tested in comparison with those in Example 1.

Samples H and I were prepared with the same method as for Sample C in Example 1 except that no silane was added (0 wt. % silane).

The sample information and viscosity results are summarized in Table 4.

TABLE 4
Effect of different fumed silica or fumed metal oxide
in thermal conductive materials with PCTP 12 hBN on
viscosity at 6 rpm and 60 rpm, with or without silane treatment

| | | | | viscosity | viscosity |
|---|---|---|---|---|---|
| | | wt. % fumed | wt. % | at 6 rpm, | at 60 rpm, |
| samples | description | oxide | silane | cP | cP |
| A | PCTP 12 | 0 | 0 | 3099 | 886 |
| B | PCTP 12/ | 0 | 2% | 1300 | 450 |
| | Dynasylan ® | | | | |
| | Glymo | | | | |
| C | PCTP 12/ | 5% | 2% | 210 | 107 |
| | AEROSIL ® | AEROSIL ® | | | |
| | 200/Dynasylan ® | 200 | | | |
| | Glymo | | | | |
| H | PCTP 12/ | 5% | 0 | 250 | 92.5 |
| | AEROSIL ® | AEROSIL ® | | | |
| | R 711 | R 711 | | | |
| D | PCTP 12/ | 5% | 2% | 85 | 61 |
| | AEROSIL ® R | AEROSIL ® | | | |
| | 711/Dynasylan® | R 711 | | | |
| | Glymo | | | | |
| I | PCTP 12/ | 5% | 0 | 34 | 46 |
| | AEROXIDE ® | AEROXIDE ® | | | |
| | Alu C 805 | Alu C 805 | | | |
| G | PCTP 12/ | 5% | 2% | 10 | 38 |
| | AEROXIDE ® | AEROXIDE ® | | | |
| | Alu C 805/ | Alu C 805 | | | |
| | Dynasylan ® | | | | |
| | Glymo | | | | |

As shown in Table 4 and FIG. 3, in comparison with Comparative Examples 1 and 2 (Samples A and B), Sample H of Example 2 treated with hydrophobic fumed silica but without silane showed substantially decreased viscosity similar to Sample C of Example 1, indicating that hydrophobic fumed silica could reach similar viscosity decrease performance as hydrophilic fumed silica with silane. In comparison with Sample D of Example 1, the viscosity reduction of Sample H of Example 2 was worse, indicating that treatment with both hydrophobic fumed silica and silane could further decrease the viscosity compared with treatment with hydrophobic fumed oxide only. Similarly, among Samples A, B, I, G, Sample I of Example 2 treated with hydrophobic alumina had an obviously decreased viscosity, but the viscosity reduction was less than for Sample G of Example 1 with both alumina and silane treatment. It shows that hydrophobic oxide could obviously reduce the viscosity when silane was not used, but silane treatment could further decrease the viscosity.

### Comparative Example 3

### Different Boron Nitride

Sample J was prepared as Comparative Example 3 with the same method as for Sample A of Comparative Example 1 except that boron nitride PCTP 8 was used in this example instead of PCTP 12.

### Example 3

### Different Boron Nitride

Samples K and L of Example 3 were prepared with the same method as Sample C of Example 1 except that boron nitride PCTP 8 was used in this example instead of PCTP 12.

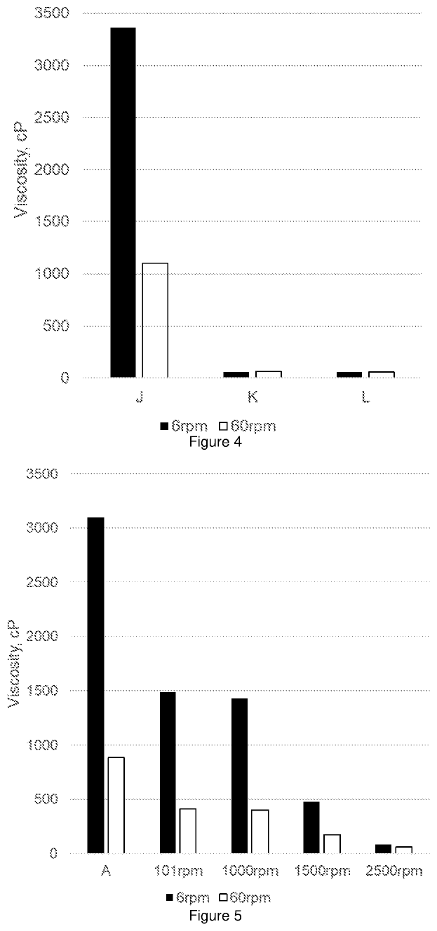

The viscosity results of Samples J, K and L are summarized in Table 5. FIG. 4 compares the performance.

TABLE 5
Effect of different fumed silica or fumed metal oxide in thermal conductive
materials with PCTP 8 hBN on viscosity at 6 rpm and 60 rpm

| | | wt. % Fumed | wt. % | Viscosity at | Viscosity at |
|---|---|---|---|---|---|
| Samples | Description | silica or oxide | Silane | 6 rpm, cP | 60 rpm, cP |
| J | PCTP 8 | 0 | 0 | 3359 | 1100 |
| K | PCTP 8/AEROSIL ® | 5% AEROSIL ® | 2% | 60 | 65 |
| | 200/Dynasylan ® Glymo | 200 | | | |
| L | PCTP 8/AEROSIL ® R | 5% AEROSIL ® | 2% | 55 | 57 |
| | 711/Dynasylan ® Glymo | 200 | | | |

As shown in Table 5 and FIG. 4, similarly to PCTP 12, fumed silica and metal oxides show significant viscosity decrease effect on PCTP 8 samples. It can be concluded that the method of the invention is effective to different hBN materials.

### Example 4

### Different Mixing Speed

Compared with Example 1, different mixing speed was applied in this example.

Thermal conductive material samples D-101, D-1000, D-1500 and D-2500 were prepared with different mixing speeds. Low speed Turbula mixing at 101 rpm and high speed dual asymmetric centrifugal mixing at 1000 rpm, 1500rpm and 2500rpm were applied in the mixing of PCTP 12 boron nitride and 5 wt. % AEROSIL® R 711, and also applied in mixing of PCTP 12 boron nitride and 2 wt. % saline Dynasylan® Glymo. The other steps were same as Sample D of Example 1.

The viscosity results at different mixing speeds are summarized in FIG. 5. Compared with the viscosity of Sample A in Comparative Example 1, the viscosity of the thermal conductive materials decreased gradually when the fumed silica and the silane was added under the mixing speed of 101 rpm, 1000 rpm, 1500 rpm and 2500 rpm, respectively. In addition, the viscosity at mixing speed 1500 rpm and 2500 rpm showed significant decrease compared to the viscosity at mixing speed 101 rpm and 1000 rpm. The viscosity at mixing speed 2500 rpm showed significant decrease when compared to the viscosity at mixing speed 1500 rpm. Such reduction of viscosity is surprising and indicates that mixing speed is important to viscosity decrease. For this example, mixing speed above 101 rpm in preparation of thermal conductive filler was effective in decreasing the viscosity of the thermal conductive material, and mixing speed above 1500 rpm was preferred to reach a better effect.

### Example 5

### Different Fumed Oxide Loading

To study the influence of different fumed silica loading, thermal conductive materials with 0 wt. %, 2 wt. %, 5 wt. %, 7 wt. %, 10 wt. %, respectively, of AEROSIL® R 711 in boron nitride was prepared with the same method as for Sample D of Example 1 except for the different silica loading.

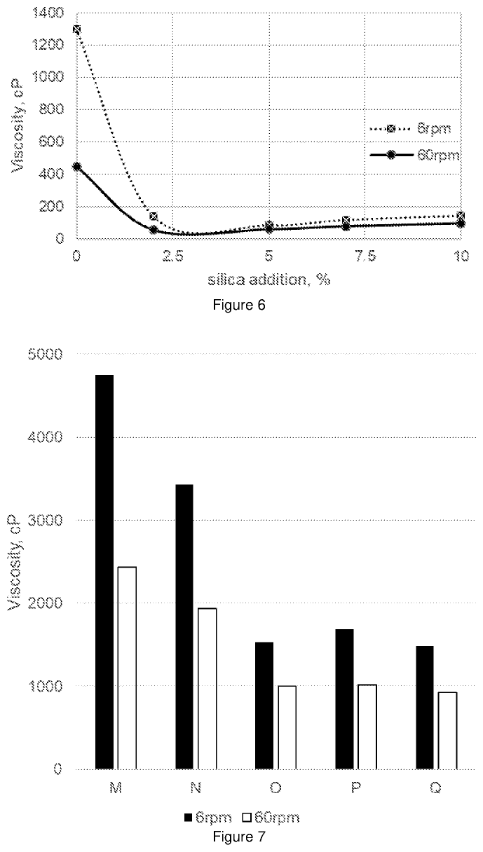

The viscosity results with the rotor speed of 6 rpm and 60 rpm are summarized in FIG. 6.

Addition of AEROSIL® R 711 could significantly reduce the viscosity of the thermal conductive material, but the viscosity increased only slightly when the amount of AEROSIL® R 711 was more than 5wt. %. The optimum loading for the lowest viscosity was between 2 wt. % to 5 wt. %.

### Comparative Examples 4 and 5

### Different Resin for Thermal Conductive Materials

The thermal conductive material Sample M without any metal oxide or silane treatment was prepared as Comparative Example 4 as follows.

56 g 50 wt. % PPE resin solution with MEK as solvent was added with 28 g hBN PCTP 12. The mixture was mixed with a dual asymmetric centrifugal mixing under 2500 rpm for 30 s.

The thermal conductive material Sample N with silane but without oxide treatment was prepared as Comparative Example 5 as follows.

50 g of boron nitride PCTP 12 was placed in a 50 mL plastic vessel. Then 1 g of Dynasylan® 6498 was added into the vessel, followed by tumbling with dual asymmetric centrifugal mixing at 2500 rpm for 30 s, then the mixture was heated in an oven at 105° C. for 1 hour to obtain a thermal conductive filler. After the thermal conductive filler was prepared, 28 g of this thermal conductive filler was added to 56 g 50 wt. % PPE resin solution with MEK as a solvent. Then the mixture was mixed by the dual asymmetric centrifugal mixer at 2500 rpm for 30 s to obtain thermal conductive material Sample N.

### Example 6

### Different Resin for Thermal Conductive Material

In this example, a different resin, polyphenylene ether (PPE) resin NORYL™ SA9000 was used.

Thermal conductive materials Samples O, P and Q of Example 6 were prepared as follows,
a) Thermal conductive fillers (surface treated hBN) of Samples O, P and Q were prepared by the same method as thermal conductive fillers of Samples C, D, G respectively in Example 1 except that Dynasylan® 6498 was chosen as silane for surface treatment instead of Dynasylan® Glymo.
b) Then a 50 wt. % PPE resin NORYL™ SA9000 solution was prepared in MEK solvent by adding 500 g NORYL™ SA9000 into 500 g MEK solvent in a beaker. Magnetic stirrer was used to make the PPE dissolved in MEK solvent. Then 56 g 50 wt. % PPE solution was added with 28 g the above prepared thermal conductive fillers. The mixture was mixed with dual asymmetric centrifugal mixing under 2500 rpm for 30 s.

The final thermal conductive materials were tested for viscosity under the rotor speed of 6 rpm and 60 rpm with Brookfield DV-II+Pro Viscometer. The viscosity is shown in FIG. 7 and Table 6.

TABLE 6
Effect of different fumed silica or fumed metal oxide in thermal conductive
materials with PCTP 12 hBN on viscosity of PPE resin at 6 rpm and 60 rpm

| | | wt. % Fumed silica or | wt. % | Viscosity at | Viscosity at |
|---|---|---|---|---|---|
| Samples | Description | fumed metal oxide | Silane | 6 rpm, cP | 60 rpm, cP |
| M | PCTP 12 | 0 | 0 | 4755 | 2434 |
| N | PCTP 12/Dynasylan ® | 0 | 2% | 3433 | 1936 |
| | 6498 | | | | |
| O | PCTP 12/AEROSIL ® | 5% AEROSIL ® 200 | 2% | 1533 | 1005 |
| | 200/Dynasylan ® 6498 | | | | |
| P | PCTP 12/AEROSIL ® R | 5% AEROSIL ® | 2% | 1692 | 1020 |
| | 711/Dynasylan® 6498 | R 711 | | | |
| Q | PCTP 12/AEROXIDE ® | 5%AEROXIDE ® | 2% | 1488 | 928 |
| | Alu C 805/Dynasylan ® | Alu C805 | | | |
| | 6498 | | | | |

FIG. 7 and Table 6 show that fumed silica and metal oxides decrease the viscosity of the PPE thermal conductive material. This indicates the viscosity reduction effect of the thermal conductive filler of the invention can be applied to different thermal conductive materials with various resins.

### Comparative Example 1

### PH

Thermal conductive material Sample R without silica/metal oxide or silane treatment was prepared according to the same method as that of Sample A of Comparative Example 1 except that hydroxyl-terminated liquid polybutadiene POLYVEST® HT was used in Comparative Example 1-PH instead of D.E.R.™ 331 epoxy resin.

### Example 7

### Different Resin for Thermal Conductive Material

In this example, a different resin, hydroxyl-terminated liquid polybutadiene POLYVEST® HT was used.

Thermal conductive materials Samples S and T of Example 7 were prepared as follows,
a) Thermal conductive fillers (surface treated hBN) of Samples S and T were prepared by the similar method as thermal conductive fillers of Sample G in Example 1 except that Dynasylan® MEMO was used for Sample S and Dynasylan® 6598 was used for Sample T as silane for surface treatment instead of Dynasylan® Glymo.
b) Then a 50 wt. % polybutadiene POLYVEST® HT solution was prepared in MEK solvent by adding 500 g POLYVEST® HT into 500 g MEK solvent in a beaker. Magnetic stirrer was used to make the POLYVEST® HT dissolved in MEK solvent. Then 50 g 50 wt. % POLYVEST® HT solution was added with 25 g the above prepared thermal conductive fillers. The mixture was mixed with dual asymmetric centrifugal mixing under 2500 rpm for 30 s.

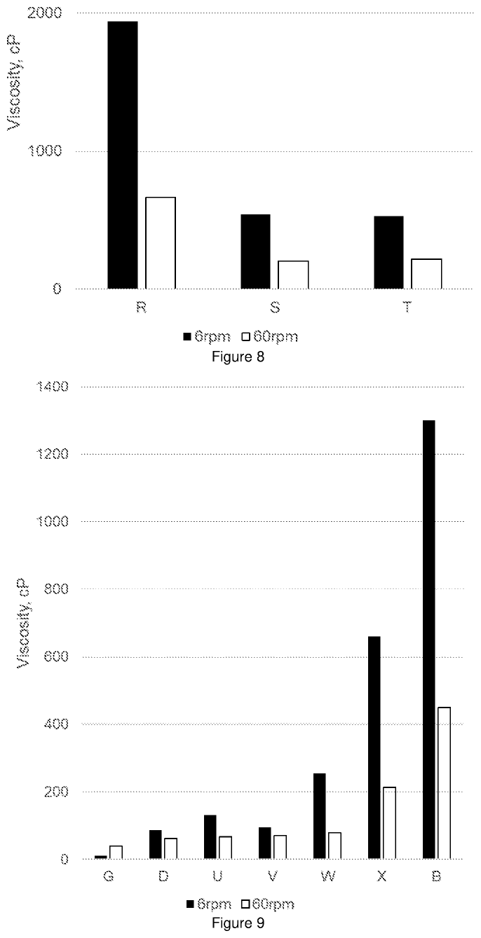

The final thermal conductive materials were tested for viscosity under the rotor speed of 6 rpm and 60 rpm with Brookfield DV-II+Pro Viscometer. The viscosity is shown in FIG. 8 and Table 7.

TABLE 7
Effect of different fumed silica or fumed metal oxide in thermal conductive materials
with PCTP 12 hBN on viscosity of polybutadiene resin at 6 rpm and 60 rpm

| | | wt.% Fumed silica | | Viscosity | Viscosity |
|---|---|---|---|---|---|
| | | or fumed metal | wt. % | at 6 rpm, | at 60 rpm, |
| Samples | Description | oxide | Silane | cP | cP |
| R | PCTP 12 | 0 | 0 | 1940 | 662 |
| S | PCTP 12/AEROXIDE ® | 5% AEROXIDE ® | 2% | 540 | 202 |
| | Alu C 805/Dynasylan ® | Alu C 805 | | | |
| | MEMO | | | | |
| T | PCTP 12/AEROXIDE ® | 5% AEROXI E ® | 2% | 530 | 214 |
| | Alu C 805/Dynasylan ® | Alu C 805 | | | |
| | 6598 | | | | |

FIG. 8 and Table 7 show that the fumed silica and metal oxides treatment to boron nitride in Example 7 decrease the viscosity of the polybutadiene thermal conductive material. This confirms the conclusion that the viscosity reduction effect of the thermal conductive filler of the invention can be applied to different thermal conductive materials with various resins.

### Comparative Example 6

### Viscosity Affected by Silica with Different Particle Sizes

Thermal conductive material Samples U, V, W, X with silica of different particle size were prepared as Comparative Example 6 as follows:
a) preparation of thermal conductive fillers:
1) 47.5 g of boron nitride PCTP 12 was placed in a 50 mL plastic vessel.
2) Next, 2.5 g of ADMAFINE® SO-C1 or ADMAFINE® SO-C4 or ADMAFINE® SO-C6 or SIPERNAT® 622 LS was put into the vessel.
3) The mixture in the vessel was tumbled with a dual asymmetric centrifugal mixer at 2500 rpm for 30 s.
4) Then 1 g Dynasylan® Glymo was added into the vessel, followed by tumbling with dual asymmetric centrifugal mixing at 2500 rpm for 30 s, then the mixture was heated in an oven at 105° C. for 1 hour.

In the prepared thermal conductive filler, the loading of fumed silica or fumed metal oxide was 5 wt. % and loading of silane was 2 wt. % based on the weight of untreated boron nitride.
b) preparation of thermal conductive materials:

After the thermal conductive filler was prepared, 28 g D.E.R.™ 331 epoxy resin, 24 g methyl ethyl ketone (MEK) as solvent and 28 g thermal conductive filler (treated boron nitride) were mixed together with the dual asymmetric centrifugal mixing at 2500 rpm for 30 s. The content of thermal conductive filler in the thermal conductive material was 50% after the solvent MEK was evaporated.

TABLE 8
Effect of different particle size silica in thermal conductive
materials with PCTP 12 hBN on viscosity at 6 rpm and 60 rpm

| | | | | viscosity | viscosity |
|---|---|---|---|---|---|
| | | wt. % fumed | wt. % | at 6 rpm, | at 60 rpm, |
| Samples | description | oxide | silane | cP | cP |
| U | PCTP 12/ | 5% | 2% | 131 | 67 |
| | ADMAFINE ® | ADMAFINE® | | | |
| | SO-C1/Dynasylan ® | SO-C1 | | | |
| | Glymo | | | | |
| V | PCTP 12/ | 5% | 2% | 94 | 70 |
| | ADMAFINE ® | ADMAFINE® | | | |
| | SO-C4/Dynasylan ® | SO-C4 | | | |
| | Glymo | | | | |
| W | PCTP 12/ | 5% | 2% | 254 | 78 |
| | ADMAFINE ® | ADMAFINE® | | | |
| | SO-C6/Dynasylan® | SO-C6 | | | |
| | Glymo | | | | |
| X | PCTP 12/ | 5% | 2% | 660 | 213 |
| | SIPERNAT ® | SIPERNAT® | | | |
| | 622 LS/Dynasylan ® | 622 LS | | | |
| | Glymo | | | | |

As shown in Table 8 and FIG. 9, the large size silica ADMAFINE® SO-C1, ADMAFINE®

SO-C4, ADMAFINE® SO-C6 and SIPERNAT® 622 LS also decreased the viscosity of thermal conductive materials compared to Sample B with silane but without any oxide treatment prepared in Comparative Example 2. Compared to Sample D and G of Example 2, such silicas with particle size above 200 nm (0.2 μm) showed much worse viscosity reduction performance than AEROXIDE® Alu C 805 and AEROSIL® R 711. More importantly, as shown in following Example 8, such silicas with particle size above 200 nm showed much lower thermal conductivities of thermal conductive materials compared with thermal conductive materials with silicas of particle size below 200 nm thus such silicas are inferior for use in thermal conductive materials and are not within the scope of the oxides in the invention.

### Example 8

### Thermal Conductivity Test in Epoxy Resin Thermal Conductive Materials

Thermal conductivity of the thermal conductive materials was measured according to the procedure as follows:

To 80 g of each of the thermal conductive materials Sample A, B, D, G, U, V, W, X prepared in Comparative Example 1, Comparative Example 2, Example 1 and Comparative Example 6, 1.6 g of a cross-linker 2-cyanoguanidine and 0.015 g of a catalyst 2-methylimidazole were added. Then dual asymmetric centrifugal mixing at 2500 rpm for 30 s was applied to mix it well. The final mixture was dried under 60° C. and 20 mbar in a vacuum oven for 24 hours to remove the solvent and bubbles. Then each sample was placed to an oven at 120° C. for 8 hours to get thermal conductive material Sample A′, B′, D′, G′, U′, V′, W′, X′ respectively. The thermal conductivities of the samples were tested, and the results are shown in Table 9.

As shown in Table 9, the thermal conductive material Samples D′ and G′ showed similar thermal conductivities as Samples A′ and B′ which contained no oxides. Therefore, addition of fumed silica or fumed metal oxide didn't decrease the thermal conductivity of thermal conductive materials.

In Table 9, thermal conductive material Samples U′, V′, W′, X′ showed lower thermal conductivities than Samples A′, B′, D′, G′. This indicated that large particle size silica such as ADMAFINE® SO-C1, ADMAFINE® SO-C4, ADMAFINE® SO-C6 and SIPERNAT® 622 LS decreased the thermal conductive performance of boron nitride due to their relatively large particle sizes. By contrast, fumed silica and oxides according to the invention (such as AEROXIDE® Alu C 805 and AEROSIL® R 711) could achieve both low viscosity and high thermal conductivity.

TABLE 9
Thermal conductivity for different prepared samples in epoxy resin

| | wt. % of | | | |
|---|---|---|---|---|
| | h-BN | wt. % silica | wt. % | Thermal |
| | PCTP 12 | or metal | Glymo | conductivity, |
| Sample | in resin | oxides in resin | in resin | W/mK |
| A′ | 50 | 0 | 0 | 1.8 |
| B′ | 50 | 0 | 1% | 2.0 |
| D′ | 47.5 | 2.5 AEROSIL ®R | 1% | 1.8 |
| | | 711 | | |
| G′ | 47.5 | 2.5 AEROXIDE ® | 1% | 2.0 |
| | | Alu C805 | | |
| U′ | 47.5 | 2.5 ADMAFINE ® | 1% | 1.2 |
| | | SO-C1 | | |
| V′ | 47.5 | 2.5 ADMAFINE ® | 1% | 1.3 |
| | | SO-C4 | | |
| W′ | 47.5 | 2.5 ADMAFINE ® | 1% | 1.5 |
| | | SO-C6 | | |
| X′ | 47.5 | 2.5 SIPERNAT ® | 1% | 1.5 |
| | | 622 LS | | |

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1-15. (canceled)

16. A method for preparing a thermal conductive filler, comprising the step:
(i) dry mixing a platelet boron nitride and a fumed silica or a fumed metal oxide with a primary particle size of about 1-200 nm, and optionally the following steps;
(ii) mixing a silane into the mixture obtained in step (i);
(iii) heating the mixture obtained in step (ii).

17. The method of claim 16, wherein step (i) does not comprise calcination or chemical treatment of the boron nitride.

18. The method of claim 16, wherein the mixing in step (i) is done at a speed of above 100 rpm for at least 5 seconds.

19. The method of claim 16, wherein the average particle size of the platelet boron nitride is 1-50 μm.

20. The method of claim 16, wherein the amount of the fumed silica or fumed metal oxide is 0.1-10 wt. % based on the weight of the boron nitride.

21. The method of claim 16, wherein:
the fumed metal oxide comprises a primary particle size of 5-100 nm;
the platelet boron nitride comprises an average particle size of 1-50 μm; and
the fumed silica or fumed metal oxide is present in an amount of 2-5 wt. % based on the weight of the boron nitride.

22. The method of claim 16, wherein the fumed silica or fumed metal oxide is selected from the group consisting of: fumed hydrophilic silicas; fumed hydrophilic metal oxides;
fumed hydrophobic silicas; and fumed hydrophobic metal oxides.

23. The method of claim 22, wherein the fumed silica or the fumed metal oxide is a fumed hydrophobic silica or a fumed hydrophobic metal oxide.

24. The method of claim 22, wherein:
the fumed metal oxide comprises a primary particle size of 5-100 nm;
the platelet boron nitride comprises an average particle size of 1-50 μm; and
the fumed silica or fumed metal oxide is present in an amount of 2-5 wt. % based on the weight of the boron nitride.

25. The method of claim 16, comprising the steps:
(i) dry mixing a platelet boron nitride and a fumed silica or a fumed metal oxide with a primary particle size of about 1-200 nm;
(ii) mixing a silane into the mixture obtained in step (i);
(iii) heating the mixture obtained in step (ii).

26. The method of claim 25, wherein the fumed silica or fumed metal oxide is selected from the group consisting of: fumed hydrophilic silicas; fumed hydrophilic metal oxides;
fumed hydrophobic silicas; and fumed hydrophobic metal oxides.

27. The method of claim 25, wherein the fumed silica or fumed metal oxide is a fumed hydrophobic silica or a fumed hydrophobic metal oxide.

28. The method of claim 25, wherein:
the fumed metal oxide comprises a primary particle size of 5-100 nm;
the platelet boron nitride comprises an average particle size of 1-50 μm; and
the fumed silica or fumed metal oxide is present in an amount of 2-5 wt. % based on the weight of the boron nitride.

29. Thermal conductive material comprising:
A) a resin material;
B) a thermal conductive filler made by the method of claim 16 dispersed in the resin material;
C) a solvent, preferably methyl ethyl ketone;
D) a cross-linker; and optionally
E) a catalyst.

30. The thermal conductive material of claim 29, wherein the method for making the thermal conductive filler of paragraph B) comprises the steps:
(i) dry mixing a platelet boron nitride and a fumed silica or a fumed metal oxide with a primary particle size of about 1-200 nm;
(ii) mixing a silane into the mixture obtained in step (i);
(iii) heating the mixture obtained in step (ii).

31. The thermal conductive material of claim 30, wherein the method for making the thermal conductive filler of paragraph B) does not comprise calcination or chemical treatment of boron nitride.

32. The thermal conductive material of claim 30, wherein, in paragraph i), the fumed silica or fumed metal oxide is selected from the group consisting of: fumed hydrophilic silicas; fumed hydrophilic metal oxides; fumed hydrophobic silicas; and fumed hydrophobic metal oxides.

33. The thermal conductive material of claim 32, wherein the fumed silica or fumed metal oxide is a hydrophobic silica or a fumed hydrophobic metal oxide.

34. A thermal conductive filler comprising a platelet boron nitride powder, wherein fumed silica or fumed metal oxide particles are physically fixed on the surface of the platelet boron nitride powder, and
the average particle size of the platelet boron nitride is 1-50 μm;
the fumed silica or fumed metal oxide has a primary particle size of 1-200 nm; and
the amount of the fumed silica or fumed metal oxide is 0.1-10 wt. %, based on the weight of the boron nitride.

35. The thermal conductive filler of claim 34, wherein:
the average particle size of the platelet boron nitride is 2-20 μm;
the fumed silica or the fumed metal oxide has a primary particle size of 5-100 nm; and
the amount of the fumed silica or the fumed metal oxide is 2-5 wt. % based on the weight of the boron nitride.
